(19) United States
(12) Patent Application Publication
(10) Pub. No.: US 2021/0266431 A1
(43) Pub. Date: Aug. 26, 2021

(54) IMAGING SENSOR PIXELS HAVING BUILT-IN GRATING

(71) Applicant: SEMICONDUCTOR COMPONENTS INDUSTRIES, LLC, Phoenix, AZ (US)

(72) Inventor: Victor LENCHENKOV, Sunnyvale, CA (US)

(73) Assignee: SEMICONDUCTOR COMPONENTS INDUSTRIES, LLC, Phoenix, AZ (US)

(21) Appl. No.: 16/798,747

(22) Filed: Feb. 24, 2020

(51) Int. Cl. H04N 5/225; G02B 5/18; G02B 1/11

(52) U.S. Cl. CPC H04N 5/2254; G02B 1/11; G02B 5/1842; G02B 5/1866

(57) ABSTRACT

An image sensor may include an array of image pixels that generate charge in response to light. To determine the color of the light, each image pixel may have a built-in diffusion grating and underlying photodiodes. The diffusion grating may diffract light in a wavelength-dependent manner, and the underlying photodiodes may detect a pattern of the diffracted light. Processing circuitry may store patterns corresponding to known colors. The processing circuitry may compare the detected pattern of the diffracted light to the patterns of light of the known colors, and thereby determine the color of the light through a process such as interpolating between the known patterns. This may eliminate the need for color filters in each pixel and increase the amount of detected light within each pixel. Image sensors having pixels with diffractive gratings may be used in cameras, microscopes, Raman spectrometers, and medical devices.

### BACKGROUND

This relates generally to imaging devices, and more particularly, to image pixels that include built-in grating structures that diffract incident light and that include an array of photodiodes to detect the pattern of diffracted light.

Image sensors are commonly used in electronic devices such as cellular telephones, cameras, and computers to capture images. In a typical arrangement, an electronic device is provided with an array of image pixels arranged in pixel rows and pixel columns. Each image pixel in the array includes a photodiode that is coupled to a floating diffusion region via a transfer gate. Each pixel receives photons from incident light and converts the photons into electrical signals. Column circuitry is coupled to each pixel column for reading out pixel signals from the image pixels. Image sensors are sometimes designed to provide images to electronic devices using a Joint Photographic Experts Group (JPEG) format.

Image pixels commonly include color filters that allow light of a given wavelength to pass through to an underlying photosensitive region. As an example, an image sensor may have red, green, and blue pixels having red, green, and blue color filters. These pixels may be arranged in any desired pattern, such as a Bayer pattern, and the outputs of the pixels may be processed to produce a continuous image by interpolating the color at each pixel location. However, applying the color filters to each pixel is a time-consuming manufacturing process, a significant amount of light is lost due to the presence of the color filters, and interpolating between pixels of different colors requires extensive processing.

It would therefore be desirable to provide imaging devices having image sensor pixels without color filters.

### BRIEF DESCRIPTION OF THE DRAWINGS

FIG. 1 is a diagram of an illustrative electronic device having an image sensor and processing circuitry for capturing images using an array of image pixels in accordance with an embodiment.

FIG. 2 is a diagram of an illustrative pixel array and associated readout circuitry for reading out image signals from the pixel array in accordance with an embodiment.

FIG. 3 is a cross-sectional side view of an illustrative image pixel having a built-in diffractive grating and an array of photodiodes in accordance with an embodiment.

FIG. 4 is an illustrative graph of signals generated by an array of photodiodes under a diffractive grating at different spatial frequencies in response to light of different colors in accordance with an embodiment.

FIG. 5 is a cross-sectional side view of an illustrative hyperspectral microscope formed with an image sensor having pixels with built-in diffractive gratings in accordance with an embodiment.

FIG. 6 is a flowchart of an illustrative method of calibrating and operating a pixel having a built-in diffraction grating in accordance with an embodiment.

### DETAILED DESCRIPTION

Embodiments of the present invention relate to image sensors, and more particularly, to image sensors having pixels with built-in grating to allow for determination of the color of incident light without the use of color filters. It will be recognized by one skilled in the art, that the present exemplary embodiments may be practiced without some or all of these specific details. In other instances, well known operations have not been described in detail in order to not unnecessarily obscure the present embodiments.

Imaging systems having digital camera modules are widely used in electronic devices such as digital cameras, computers, cellular telephones, and other electronic devices. A digital camera module may include one or more image sensors that gather incoming light to capture an image. Image sensors may include arrays of image pixels. The pixels in the image sensors may include photosensitive elements such as photodiodes that convert the incoming light into electric charge. Image sensors may have any number of pixels (e.g., hundreds or thousands or more). A typical image sensor may, for example, have hundreds, thousands, or millions of pixels (e.g., megapixels). Image sensors may include control circuitry such as circuitry for operating the image pixels and readout circuitry for reading out image signals corresponding to the electric charge generated by the photosensitive elements.

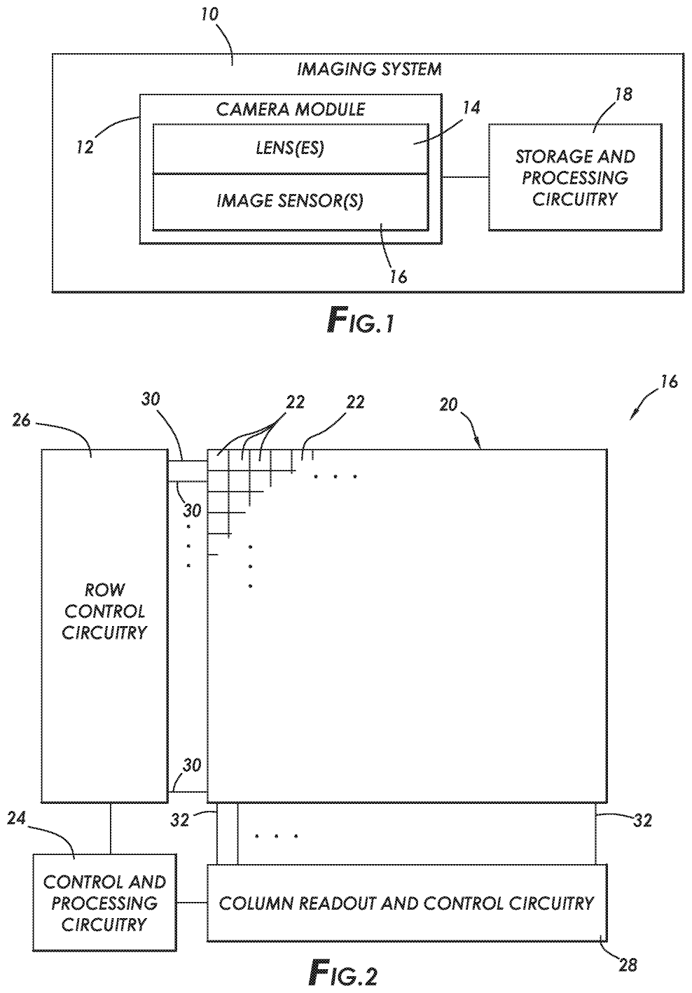

Image sensor pixels may be formed from semiconductor material, such as silicon, to absorb light incident on the pixels and convert the light into electrical current. Typically, image sensor pixels may have color filters overlying the silicon. The color filters may allow light at a specific wavelength/range of wavelengths (i.e., light of a specific color) to pass through to the underlying photosensitive silicon. In this way, each image pixel may detect how much light of the specific color is incident on the pixel, and circuitry may process the data generated by each pixel and approximate through interpolation or other methods the appropriate color for each pixel location in a final image. However, applying color filters over each image pixel in an array of pixels is a burden during manufacturing and reduces the amount of light that is captured by the image pixels (i.e., because light is filtered out by the color filters). Additionally, processing the data (e.g., through interpolation techniques such as demosaicking) after it is generated by each pixel to determine the appropriate color for each pixel location is a burden during image capture operations. Therefore, it may be desirable to form an image sensor with pixels that do not require color filters. Pixels of this nature may be included in an electronic device, such as the device of FIG. 1.

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

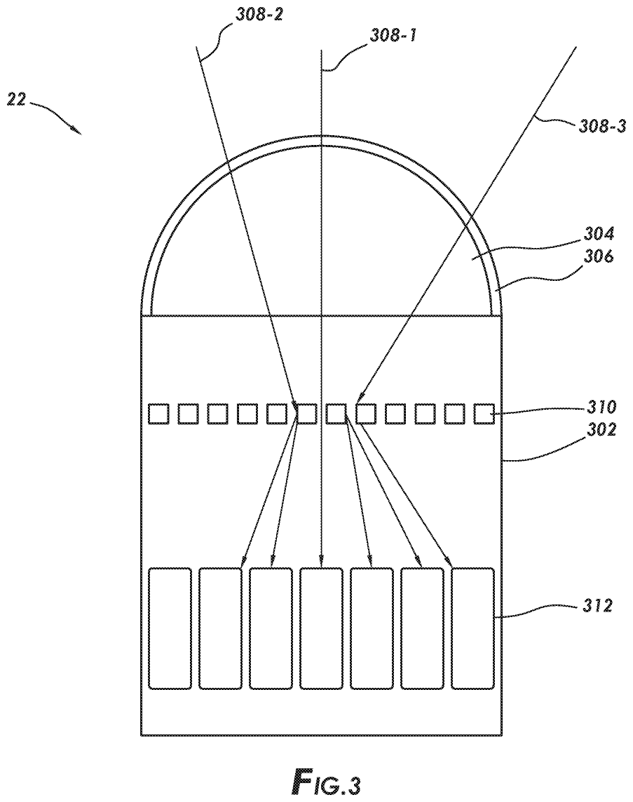

As shown in FIG. 2, image sensor 16 may include a pixel array 20 containing image sensor pixels 22 arranged in rows and columns (sometimes referred to herein as image pixels or pixels) and control and processing circuitry 24. Array 20 may contain, for example, hundreds or thousands of rows and columns of image sensor pixels 22. Control circuitry 24 may be coupled to row control circuitry 26 and image readout circuitry 28 (sometimes referred to as column control circuitry, readout circuitry, processing circuitry, or column decoder circuitry). Row control circuitry 26 may receive row addresses from control circuitry 24 and supply corresponding row control signals such as reset, row-select, charge transfer, dual conversion gain, and readout control signals to pixels 22 over row control paths 30. One or more conductive lines such as column lines 32 may be coupled to each column of pixels 22 in array 20. Column lines 32 may be used for reading out image signals from pixels 22 and for supplying bias signals (e.g., bias currents or bias voltages) to pixels 22. If desired, during pixel readout operations, a pixel row in array 20 may be selected using row control circuitry 26 and image signals generated by image pixels 22 in that pixel row can be read out along column lines 32.

Image readout circuitry 28 (sometimes referred to as column readout and control circuitry 28) may receive image signals (e.g., analog pixel values generated by pixels 22) over column lines 32. Image readout circuitry 28 may include sample-and-hold circuitry for sampling and temporarily storing image signals read out from array 20, amplifier circuitry, analog-to-digital conversion (ADC) circuitry, bias circuitry, column memory, latch circuitry for selectively enabling or disabling the column circuitry, or other circuitry that is coupled to one or more columns of pixels in array 20 for operating pixels 22 and for reading out image signals from pixels 22. ADC circuitry in readout circuitry 28 may convert analog pixel values received from array 20 into corresponding digital pixel values (sometimes referred to as digital image data or digital pixel data). Image readout circuitry 28 may supply digital pixel data to control and processing circuitry 24 and/or processor 18 (FIG. 1) over path 25 for pixels in one or more pixel columns.

If desired, image pixels 22 may include one or more photosensitive regions for generating charge in response to image light. Photosensitive regions within image pixels 22 may be arranged in rows and columns on array 20.

Image sensor 16 may be configured to support a global shutter operation (e.g., pixels 22 may be operated in a global shutter mode). For example, the image pixels 22 in array 20 may each include a photodiode, floating diffusion region, and local charge storage region. With a global shutter scheme, all of the pixels in the image sensor are reset simultaneously. A charge transfer operation is then used to simultaneously transfer the charge collected in the photodiode of each image pixel to the associated charge storage region. Data from each storage region may then be read out on a per-row basis, for example.

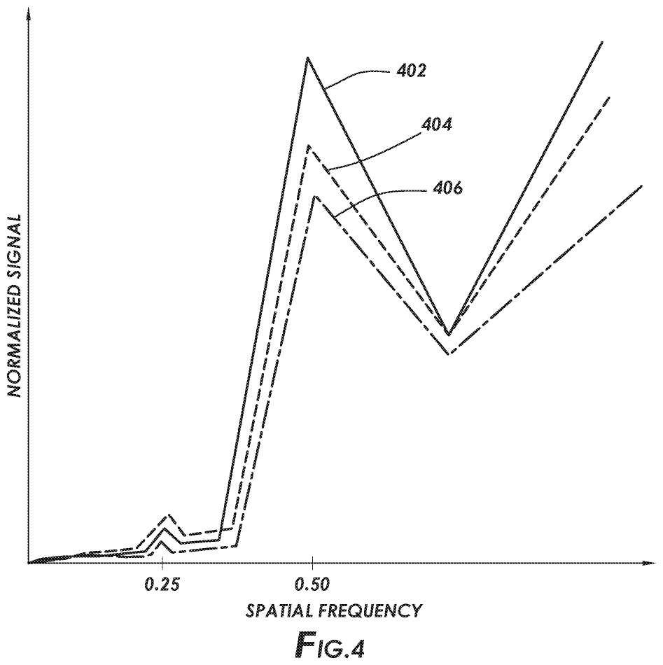

Image pixels 22 in array 20 may include structures that allow for detection of the wavelength of light incident on each pixel without using color filter structures. As shown in FIG. 3, pixel 22 may include silicon substrate 302. Silicon may absorb light incident on pixel 22 (i.e., may absorb photons of the light) to determine how much light has reached the pixel. Microlens 304 may be formed on the backside of silicon substrate 302 (if the image sensor is a backside-illuminated image sensor). Microlens 304 may focus incident light, such as incident light 308, onto silicon substrate 302, thereby allowing the silicon substrate to absorb photons of the light. If desired, microlens 304 may be a gapless microlens and may be formed from any desired material, such as silicon nitride (SiN). Microlens 304 may be a convex spherical lens, as shown in FIG. 3. However, this is merely illustrative. Microlens 304 may be formed from acrylic, glass, or any other material, and may have concave portions, trench portions, or any other shape. In general, any desired shape and/or material may be used to form microlens 304 and focus the light on the photosensitive silicon layer 302.

Antireflective coating 306 may coat the upper surface of microlens 304. In particular, antireflective coating 306 may be formed from silicon dioxide (SiO₂), or may be formed from any other desired material. In general, antireflective coating 304 may reduce the reflections of light incident on microlens 304, thereby allowing more light to pass through the microlens and to ultimately be absorbed by silicon layer 302. However, this is merely illustrative. In general, microlens 304 may be coated with any desired antireflective coating or may be uncoated. Additionally or alternatively, microlens 304 may be coated with other desired coatings.

To detect the color of incident light 308 without relying upon a color filter, pixel 22 may include diffraction grating 310. Diffraction grating 310 may also be referred to as a diffractive grating, a grating, and a built-in grating herein. Diffraction grating 310 may include objects that are spaced apart within substrate 302 to diffract incident light 308. In other embodiments, it may be desirable to apply grating 310 above substrate 302. Regardless of the location of diffraction grating 310, the grating may diffract light incident on pixel 22 as it enters or passes through substrate 302. As shown in FIG. 3, light 308-1 may enter at a normal angle with respect to a top surface of substrate 302 and be largely unaffected by diffraction grating 310. However, light 308-2 and light 308-3, which may enter at higher angles of incidence with respect to the top surface of substrate 302, may diffract at larger angles. Additionally, diffraction grating 310 may be designed to diffract some wavelengths of light to a greater extent than other angles of light. In other words, diffraction grating 310 may diffract certain colors to a greater extent than other colors. As an example, light of a first color may reach photodiodes further from the center of pixel 22, while light of a second color may only reach the central photodiodes of array 312.

In general, diffraction grating 310 may formed using any desired material For example, diffraction grating 310 may be formed from silicon nitride (SiN). The individual portions of diffraction grating 310 may be referred to as diffractive lines and diffractive members herein. The individual portions of diffraction grating 310 may be spaced in any desired manner. For example, the portions may be spaced uniformly across pixel 22, they may be concentrated more at the central portion of pixel 22 than at the edges of pixel 22, or they may be concentrated more at the edge portions of pixel 22 than at the central portion of pixel 22, as examples. Additionally, the diffractive lines may have a width of less than 200 nm, less than 300 nm, less than 400 nm, greater than 100 nm, or any other desired width. The diffractive lines may be spaced at less than 1000 lines/mm, at more than 1000 lines/mm, at less than 2000 lines/mm, at less than 3000 lines/mm, or at any other desired spacing.

Moreover, although diffraction grating 310 has been shown in FIG. 3 as a two-dimensional line of three-dimensional objects/diffraction lines (although wires or other structures may be used instead) that are spaced apart to diffract light, a three-dimensional grating may be used instead. In particular, a three-dimensional grating (introducing a vertical dimension to the grating), may allow the pitch of the grating to be varied across pixel 22 in both horizontal and vertical directions. Alternatively or additionally, wires may be used instead of three-dimensional objects. For example, it may be desirable to reduce the size of the openings in diffusion grating 310 by increasing the density of the diffractive members, or it may be desired to have many diffraction lines (e.g., hundreds or thousands of lines). However, this is merely illustrative. In general, any desired number of diffraction lines may be formed from any desired type of material and any desired type of grating.

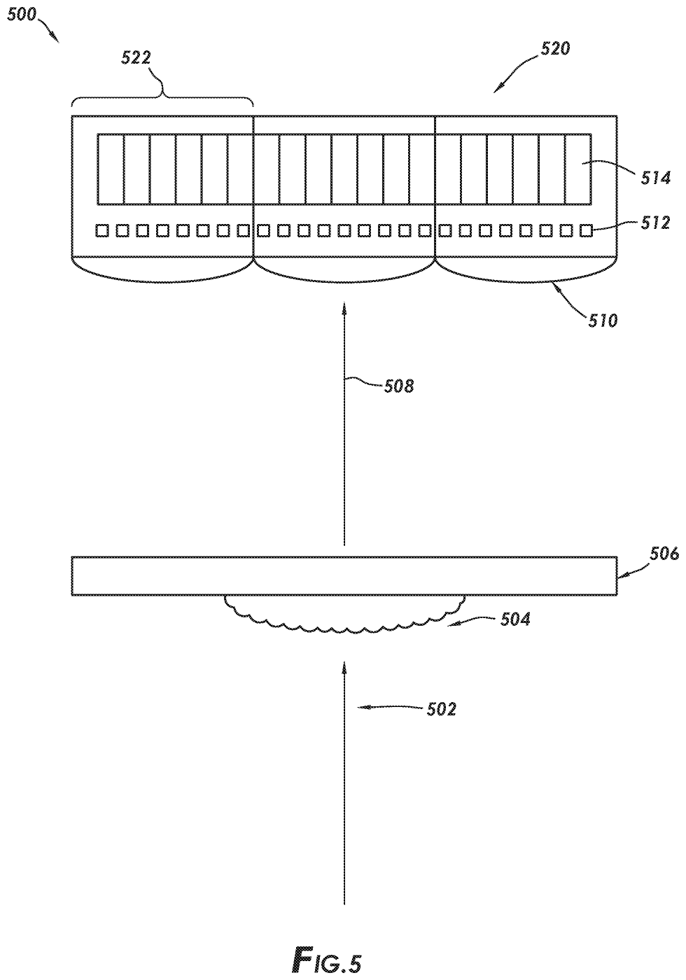

Because of the aforementioned diffraction difference (e.g., the difference in the amount of diffraction) between different colors, an array of photodiodes 312 may be used to measure the light at different positions within pixel 22, and spatial information of the light at may be used to determine a color of the incident light. For example, each photodiode within array 312 may detect light, and processing circuitry may use information regarding the amount of light at each location in the array to determine the color of the incident light. In other words, because each color of incident light will diffract to different extents (i.e., will have different angles of diffraction), processing circuitry can determine the color of the light based on the diffraction pattern measured by photodiode array 312. Although photodiode array 312 has been shown with seven photodiodes, this is merely illustrative. Photodiode array 312 may have more than four photodiodes, more than five photodiodes, fewer than 10 photodiodes, or more than eight photodiodes. In general, photodiode array 312 may have any desired number of photodiodes to detect the diffraction pattern of the light. A graph showing an illustrative diffraction difference for different colors of light is shown in FIG. 4.

As shown in FIG. 4, a normalized signal generated by each of the photodiodes of array 312 may be plotted against spatial frequency, which corresponds to the frequency and distance of the photodiode from the center of the image pixel. In particular, lines 402, 404, and 406 may be illustrative lines corresponding to measurements of light of different colors. For example, line 402 may correspond to the signals generated by blue incident light, line 404 may correspond to the signals generated by green incident light, and line 406 may correspond to the signal generated by red incident light. In general, however, signals generated in response to light of any incident color may be plotted in a similar manner.

As shown, line 402 may exhibit a peak response at a spatial frequency of 0.5, followed by smaller responses by line 404 and 406. Therefore, blue light may have the highest signal at a spatial frequency of 0.5. At a spatial frequency of approximately 0.25, however, line 404 (corresponding to a green color) may have the highest signal, followed by blue and red. Processing circuitry may use the signal at each spatial frequency to determine what color is incident on image pixel 22. In other words, the processing circuitry may compare a pattern of the light incident on photodiode array 312 to known patterns of light diffraction for different colors. For example, the known patterns of light may be stored as data in a lookup table. These patterns may be determined during manufacturing by calibrating the pixel array.

During calibration, different known colors may be used and the spatial frequency measured. For example, red, green, blue, magenta, cyan, yellow, and/or white (and any combinations of these colors or other desired colors) may be used during calibration. This will provide processing circuitry with a number of known spatial frequency spectrums (KSFS). During later use of the image sensor, the processing circuitry may compare the measured spatial frequency spectrum of incoming light to the known spectrums. For example, a comparison may be performed using Equation 1,

Difference=Σₛ₌₀^{N}^{_{y}}|USFS(s)−KSFS(s)| (1)

wherein USFS is the unknown spatial frequency spectrum of the incoming light, s is the spatial frequency, and N_{y} is the number of photodiodes in array 312. Equation 1 may be used to determine differences between the unknown spatial frequency spectrum and each known spectrum (e.g., each known spectrum corresponding to each color used for calibration), and the processing circuitry may calculate the color of the incoming light based on these differences (e.g., by interpolating between the known spectrums).

However, the method of using the difference between known and unknown spectrums at each point of the photodiode array is merely illustrative of one way to determine the color using the diffraction pattern of the light. For example, instead of analyzing the signal at each position, the signal across the array may be added together (e.g., the signals detected by each of the photodiodes 312 may be summed). The processing circuitry may be calibrated using different colors of light, and the sum of measurements at all spatial frequencies (i.e., at each photodiode) may be stored within the processing circuitry. When an unknown image is analyzed, the sum of the spatial frequencies of the unknown image may be compared to the stored values to determine the color of the light. In general, however, any desired method of determining the light based on the diffraction pattern may be used.

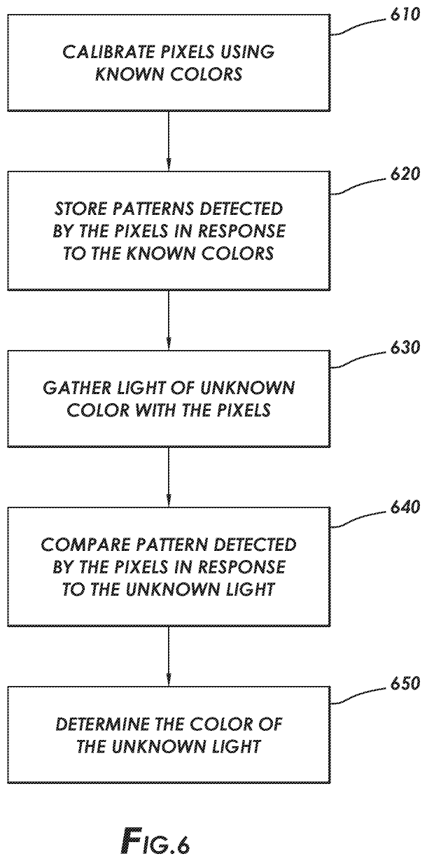

While the in-pixel diffractive grating has been discussed in connection with image sensors, such as those in cameras, this is merely illustrative. In general, the diffractive grating concept may be used in any imaging device. An example of such a device is shown in FIG. 5.

As shown in FIG. 5, diffractive grating may be used in forming a hyperspectral microscope, such as microscope 500. Microscope 500 may include image sensor 520. Image sensor 520 may include pixels, such as pixel 522. Pixel 522 may include the microlens, diffractive grating, and photodiode array previously described in connection with FIG. 3. These features are shown as microlens 510, diffractive grating 512, and photodiode array 514 in FIG. 5. However, to ensure that microscope 500 has sufficient sensitivity, diffractive grating 512 may be formed from metal lines, with more than 1000 lines/mm, more than 2000 lines/mm, less than 4000 lines/mm, or more than 3000 lines/mm, as examples. In one embodiment, it may be desirable to form diffractive grating 512 from 3000 metal lines/mm. The metal lines may have widths of less than 200 nm, less than 300 nm, more than 250 nm, or less than 500 nm, as examples. Additionally, to ensure that microscope 500 is able to detect the received light 508, the metal lines used to form diffractive grating 512 may also act as a polarizer (i.e., light 508 may be polarized and diffractive grating 512 may filter unpolarized light).

Image sensor 520 may receive the light 508 after light 502 has been directed at and illuminated sample 504. Light 502 may be polarized light and sample 504 may be any desired material that a user wishes to examine. Sample 504 may rest on cover glass 506. After light 502 has passed through sample 504, the light will be modified (e.g., the spectrum of the light may be shifted) based on the composition of sample 504. Therefore, light 508 corresponds to light with a spectrum that has shifted based on the sample's composition. Image sensor 520 may then analyze the signals at each of the photodiodes in array 514 to determine the spectrum shift of the light. In addition to storing known patterns of diffraction, processing circuitry associated with hyperspectral microscope 500 may also store correlations between light spectrum shift and composition. Therefore, based on the determined spectrum shift of the light, the processing circuitry may determine the composition of sample 504.

In some cases, it may be desirable to couple the hyperspectral microscope embodiment with a laser to produce a Raman spectrometer. In particular, the same principles may be used as described previously, except that a laser may be used in addition to or in place of incident light 502. In this way, a Raman spectrometer may be formed. This may have many applications in the biomedical field, including in syringe devices that are capable of detecting malignant cells by shining a laser into the body of a patient, and in pills that may have a built in laser and image sensor that can perform internal colonoscopies of patients. However, these are merely illustrative. In general, image sensors having pixels with built-in diffractive gratings may be used in any desired application.

A method of operating pixels having built-in gratings, such as pixel 22 of FIG. 3 or pixels 522 of FIG. 5, is shown in FIG. 6. At step 610, the pixels may be calibrated using known colors. This may occur during the manufacturing of the associated image sensor or during maintenance of the image sensor, for example. During calibration, lights of various colors may be directed toward the pixel. These colors may be blue, red, and green; yellow, magenta, and cyan; white; any combination of these colors; or any other desired color(s). The charge generated by the photodiodes (such as photodiodes 312) may be analyzed by processing circuitry. In particular, the processing circuitry may determine a pattern in the signals generated by the photodiodes for each color. As previously discussed, the pattern may be based on the charge generated at each photodiode, or the pattern may be reduced to a total charge generated by all of the photodiodes.

At step 620, the patterns generated in response to the different colors may be stored within the processing circuitry. The patterns may be stored in a look up table or in any other desired method.

At step 630, the pixels may gather light of unknown color. For example, the pixels may be used by the imaging device to capture an image. In the absence of color filters, the light incident on the pixels is of an unknown color. However, the light will be diffracted by the built-in diffraction grating, and the underlying photodiodes may determine a pattern and intensity of the diffracted light.

At step 640, the processing circuitry may compare the pattern and intensity of the diffracted light to the calibration patterns stored by the processing circuitry. As previously discussed, the processing circuitry may compare the intensity of light at each photodiode of the array of photodiodes to the calibration patterns, or the processing circuitry may compare a sum of all of the photodiode values to a sum-based calibration pattern. In either case, the processing circuitry may determine a difference between the pattern generated in response to the unknown light and the calibration pattern(s). This difference may be calculated using Equation 1, or may be calculated in any other desired manner.

At step 650, the processing circuitry may determine a color of the unknown light by interpolating between each of the known calibration patterns. For example, if the pattern generated in response to the unknown light is 80% different from a blue calibration pattern, 10% different from a green calibration pattern, and 90% different from a red calibration pattern, the processing circuitry can interpolate between the blue, green, and red values to determine that the light incident on the pixel is almost entirely green with some blue and red components. However, this is merely illustrative. The processing circuitry may use any desired interpolation scheme to determine the color of the incident light.

Various embodiments have been described illustrating imaging devices having image pixels with built-in diffraction gratings that allow for the omission of color filters within the pixels.

In accordance with various embodiments, an image sensor may include an array of image pixels that generate charge in response to incident light and processing circuitry coupled to the array of image pixels. Each of the image pixels may include a plurality of photodiodes, a microlens that focuses the incident light on the plurality of photodiodes, and a diffraction grating interposed between the plurality of photodiodes and the microlens.

In accordance with some embodiments, the diffraction grating may include diffractive lines having a width of less than 400 nm and may diffract the incident light in patterns that are wavelength-dependent.

In accordance with some embodiments, the plurality of photodiodes may include at least four photodiodes and the at least four photodiodes may detect the patterns of light diffracted by the diffraction grating.

In accordance with some embodiments, the processing circuitry may include storage with pre-determined color diffraction patterns, and the processing circuitry may compare the patterns of light diffracted by the diffraction grating to the pre-determined color diffraction patterns to determine a color of the incident light.

In accordance with some embodiments, the image sensor may further include an antireflective coating on the microlens. The antireflective coating may be formed from silicon oxide and the microlens may have a convex shape to focus the incident light on the at least four photodiodes.

In accordance with some embodiments, the diffraction grating may include a two-dimensional array of diffractive lines, and the diffractive lines may be formed from silicon nitride.

In accordance with some embodiments, the plurality of diffractive lines may have a density of less than 1000 lines/mm, and each of the diffractive lines may have a width of less than 300 nm.

In accordance with some embodiments, the diffraction grating may include a three-dimensional array of three-dimensional objects, and the spacing of the three-dimensional objects may be varied across the three-dimensional array in both horizontal and vertical directions.

In accordance with some embodiments, the diffraction grating may have openings that are spaced apart to diffract light of different wavelengths at different angles.

In accordance with some embodiments, the diffraction grating may include diffraction structures selected from the group of structures consisting of: wires and three-dimensional objects.

In accordance with some embodiments, the diffraction grating may be configured to diffract blue light at a greater angle than red light and green light.

In accordance with various embodiments, a method of operating an image sensor having pixels with diffusion gratings and photodiode arrays may include applying light of one or more known colors to the pixels, determining a diffraction pattern of the light of each of the one or more known colors using processing circuitry, storing the diffraction pattern for each color in the processing circuitry, exposing the image sensor to light of unknown colors, determining a diffraction pattern of the light of the unknown colors using the processing circuitry, comparing the diffraction pattern of the light of the unknown colors to the diffraction pattern of the light of the one or more known colors, and determining the unknown colors of the light.

In accordance with some embodiments, applying the light of the one or more known colors may include applying colors selected from the group consisting of: red, green, blue, cyan, magenta, yellow, and white.

In accordance with some embodiments, determining the unknown colors of the light may include interpolating between the patterns of the light of the one or more known colors.

In accordance with some embodiments, comparing the diffraction pattern of the light of the unknown colors to the diffraction pattern of the light of the one or more known colors may include comparing the patterns at multiple locations across the photodiode arrays.

In accordance with some embodiments, comparing the diffraction pattern of the light of the unknown colors to the diffraction pattern of the light of the one or more known colors may include comparing sums of the diffraction patterns.

In accordance with various embodiments, an imaging apparatus may include an array of image pixels that generate charge in response to incident light. Each of the image pixels may include a diffractive grating that is configured to diffract the incident light in a wavelength-dependent manner, and a plurality of photodiodes that are configured to detect a pattern of the diffracted light. Processing circuitry may be coupled to the array of image pixels that may be configured to compare the pattern of the diffracted light to stored patterns of known light to determine the color of the diffracted light.

In accordance with some embodiments, the apparatus may be a Raman spectrometer and the incident light may include laser light that illuminates a sample prior to the incident light reaching the array of image pixels.

In accordance with some embodiments, the apparatus may be a hyperspectral microscope and the diffractive grating may be formed from metal lines having a density of more than 1000 lines/mm and a width of less than 300 nm.

In accordance with some embodiments, the incident light may be configured to illuminate a sample on a cover glass prior to reaching the array of pixels and the diffractive grating may be configured to polarize the incident light.

The foregoing is merely illustrative and various modifications can be made to the described embodiments. The foregoing embodiments may be implemented individually or in any combination.

What is claimed is:

1. An image sensor comprising:
an array of image pixels that generate charge in response to incident light, each of the image pixels comprising:
a plurality of photodiodes,
a microlens that focuses the incident light on the plurality of photodiodes, and
a diffraction grating interposed between the plurality of photodiodes and the microlens; and
processing circuitry coupled to the array of image pixels.

2. The image sensor defined in claim 1 wherein the diffraction grating comprises diffractive lines having a width of less than 400 nm and wherein the diffraction grating is configured to diffract the incident light in patterns that are wavelength-dependent

3. The image sensor defined in claim 2 wherein the plurality of photodiodes comprises at least four photodiodes and wherein the at least four photodiodes are configured to detect the patterns of light diffracted by the diffraction grating.

4. The image sensor defined in claim 3 wherein the processing circuitry comprises storage with pre-determined color diffraction patterns and wherein the processing circuitry is configured to compare the patterns of light diffracted by the diffraction grating to the pre-determined color diffraction patterns to determine a color of the incident light.

5. The image sensor defined in claim 4 further comprising:
an antireflective coating on the microlens, wherein the antireflective coating is formed from silicon oxide and wherein the microlens has a convex shape to focus the incident light on the at least four photodiodes.

6. The image sensor defined in claim 1 wherein the diffraction grating comprises a two-dimensional array of diffractive lines and wherein the diffractive lines are formed from silicon nitride.

7. The image sensor defined in claim 6 wherein the plurality of diffractive lines have a density of less than 1000 lines/mm and wherein each of the diffractive lines has a width of less than 300 nm.

8. The image sensor defined in claim 1 wherein the diffraction grating comprises a three-dimensional array of three-dimensional objects, and wherein the spacing of the three-dimensional objects is varied across the three-dimensional array in both horizontal and vertical directions.

9. The image sensor defined in claim 1 wherein the diffraction grating has openings that are spaced apart to diffract light of different wavelengths at different angles.

10. The image sensor defined in claim 9 wherein the diffraction grating comprises diffraction structures selected from the group of structures consisting of: wires and three-dimensional objects.

11. The image sensor defined in claim 9 wherein the diffraction grating is configured to diffract blue light at a greater angle than red light and green light.

12. A method of operating an image sensor having pixels with diffusion gratings and photodiode arrays, the method comprising:
applying light of one or more known colors to the pixels;
determining a diffraction pattern of the light of each of the one or more known colors using processing circuitry;
storing the diffraction pattern for each color in the processing circuitry;
exposing the image sensor to light of unknown colors;
determining a diffraction pattern of the light of the unknown colors using the processing circuitry;
comparing the diffraction pattern of the light of the unknown colors to the diffraction pattern of the light of the one or more known colors; and
determining the unknown colors of the light.

13. The method defined in claim 12 wherein applying the light of the one or more known colors comprises applying colors selected from the group consisting of: red, green, blue, cyan, magenta, yellow, and white.

14. The method defined in claim 13 wherein determining the unknown colors of the light comprises interpolating between the patterns of the light of the one or more known colors.

15. The method defined in claim 14 wherein comparing the diffraction pattern of the light of the unknown colors to diffraction pattern of the light of the one or more known colors comprises comparing the patterns at multiple locations across the photodiode arrays.

16. The method defined in claim 14 wherein comparing the diffraction pattern of the light of the unknown colors to diffraction pattern of the light of the one or more known colors comprises comparing sums of the diffraction patterns.

17. An imaging apparatus comprising:
an array of image pixels that generate charge in response to incident light, each of the image pixels comprising:
a diffractive grating that is configured to diffract the incident light in a wavelength-dependent manner, and
a plurality of photodiodes that are configured to detect a pattern of the diffracted light; and
processing circuitry coupled to the array of image pixels that is configured to compare the pattern of the diffracted light to stored patterns of known light to determine the color of the diffracted light.

18. The imaging apparatus defined in claim 17 wherein the apparatus is a Raman spectrometer and the incident light comprises laser light that illuminates a sample prior to the incident light reaching the array of image pixels.

19. The imaging apparatus defined in claim 17 wherein the apparatus is a hyperspectral microscope and wherein the diffractive grating is formed from metal lines having a density of more than 1000 lines/mm and a width of less than 300 nm.

20. The imaging apparatus defined in claim 19 wherein the incident light is configured to illuminate a sample on a cover glass prior to reaching the array of pixels and wherein the diffractive grating is configured to polarize the incident light.
